(19) United States
(12) Patent Application Publication
(10) Pub. No.: US 2009/0032203 A1
(43) Pub. Date: Feb. 5, 2009

(54) Balance member for curtains

(76) Inventor: Wen Ying Liang, Fuxing Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/076,367

(22) Filed: Mar. 18, 2008

(30) Foreign Application Priority Data
Aug. 1, 2007 (TW) 096128287

(51) Int. Cl. E06B 9/26

(52) U.S. Cl. 160/178.1 R

(57) ABSTRACT

A curtain includes a top head with a driving device received therein which controls multiple ropes connected to slats, wherein the last one of the slats is fixed to a top of a balance member. A plurality of connection members extend through the balance member and are fixed to the ropes. The connection members are positioned such that a torque balance is established relative to the connection members. The balance member does not tilt due to the balance of torque and a handle is formed to the balance for convenience of operation the curtain.

### FIELD OF THE INVENTION

The present invention relates to a curtain and more particularly, to a balance member connected to a lower end of Venetian blinds and the balance member does not tilt.

### BACKGROUND OF THE INVENTION

A set of conventional Venetian blinds “B” is shown in FIG. 7 and generally includes a top head 11 which is an inverted U-shaped case in which a driving device 12 is received. A plurality of slats 13 are connected with each other by two ropes 14 which are controlled by the driving device 12. The last stat 13 is fixed on a top of the bottom rail 15 and the lower ends of the ropes 14 are fixed to the bottom rail 15. The slats 13 can be lifted or lowered by operation of the driving device 12 which lifts or extends the ropes 14 to activate the slats 13. It is noted that the ropes 14 are connected to the top 151 of the bottom rail 15 at positions off from the center of the bottom rail 15 so that the weight of the bottom rail 15 drags the slats 13 to form a curved surface and the bottom rail 15 always tilts.

The present invention intends to provide a set of Venetian blinds wherein the conventional bottom rail is replaced by a balance member which is arranged so that the balance member does not tilt and the slats from a straight surface.

Furthermore, the balance member includes a handle portion which is convenient for the user to hold the balance member to operate the Venetian blinds.

### SUMMARY OF THE INVENTION

The present invention relates to a curtain which comprises a top head and a driving device is received in the top head. Multiple ropes are connected to the driving device and connect a plurality of slats. The last one of the slats is fixed to a balance member and a plurality of connection members extend through the balance member and are fixed to the ropes. The connection members are positioned such that a torque balance is established relative to the connection members.

The present invention provides a balance member connected to the lower end of the curtain and the balance member does not tilt and can be operated as a handle to lift or lower the curtain.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a curtain and the balance member of the present invention;

FIG. 2 is a perspective view to show the curtain with the balance member of the present invention, wherein the curtain is folded;

FIG. 3 is a cross sectional view to show the connection of the balance member, the connection member and the rope;

FIG. 4 illustrates the torque applied to the balance member of the present invention;

FIG. 5 is a side view to show the curtain and the balance member connected to the lower end of the curtain;

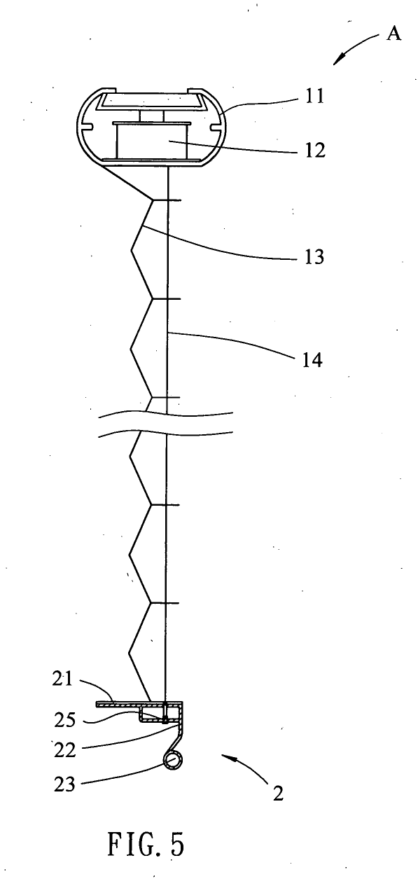

FIG. 6 is a perspective view to show the curtain with the balance member of the present invention, wherein the curtain is expanded; and

FIG. 7 is a side view to show a conventional curtain.

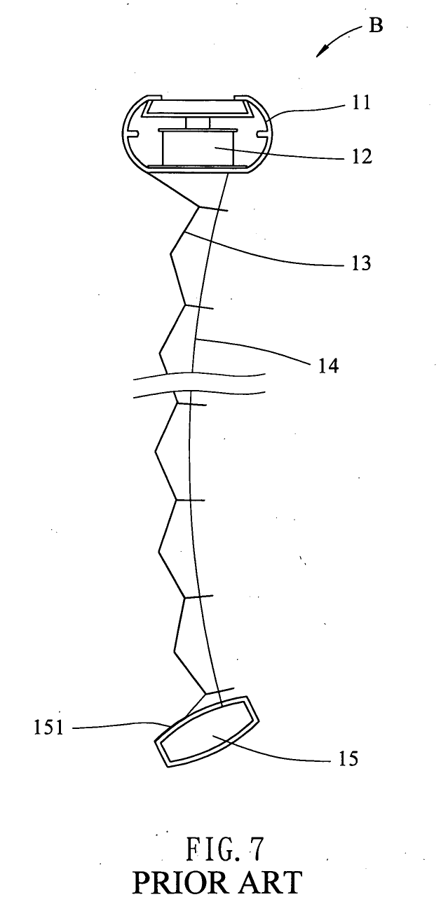

### DETAILED DESCRIPTION OF THE PREFERRED EMBODIMENT

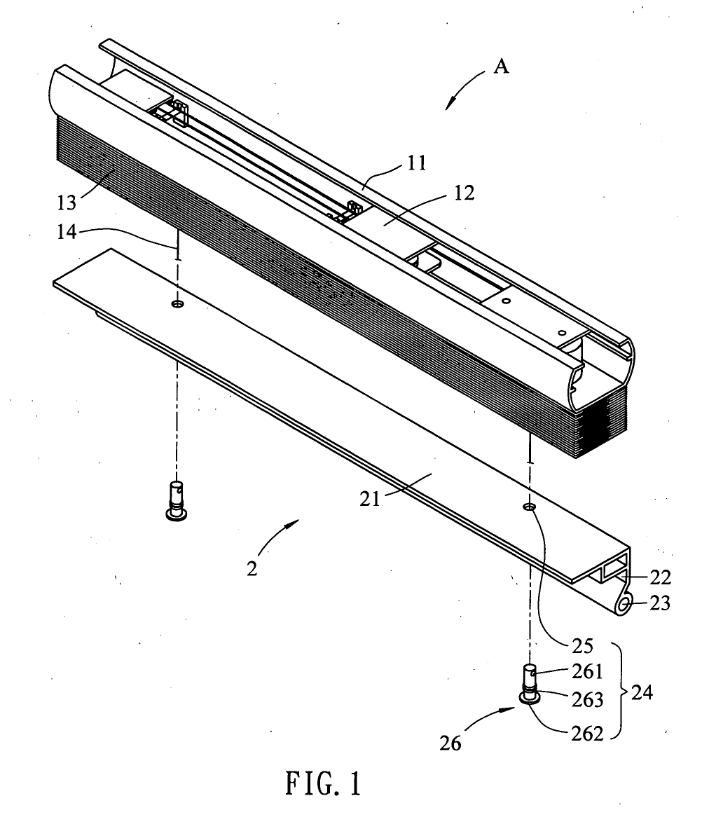

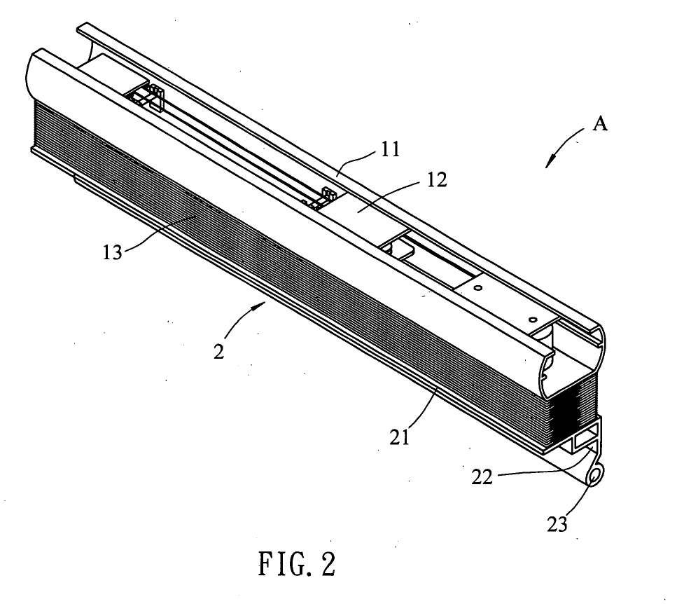

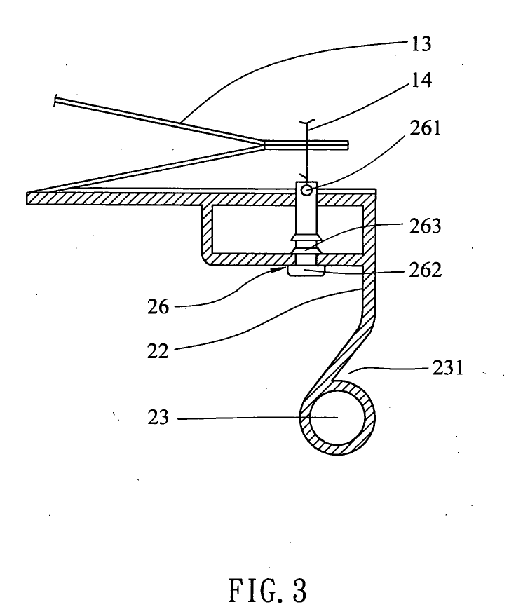

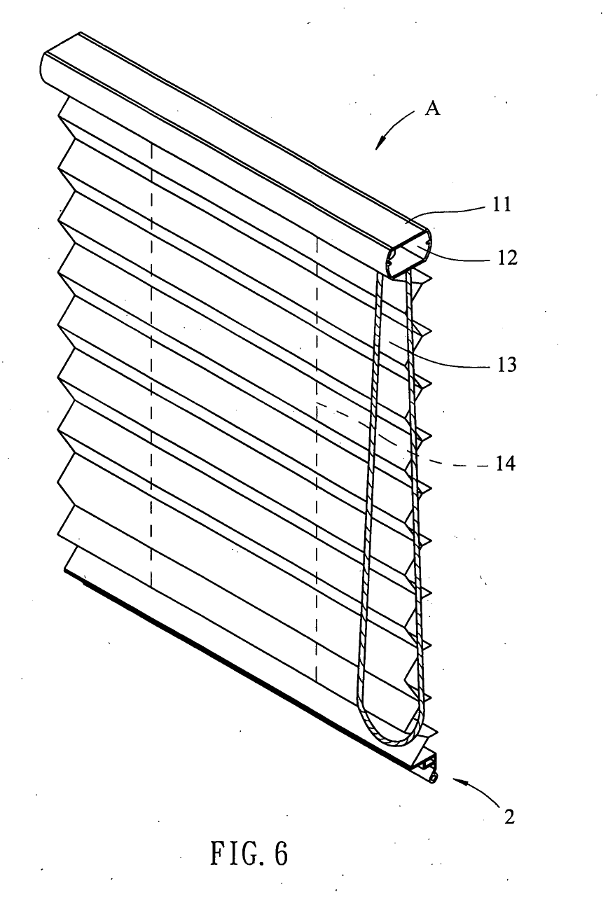

Referring to FIGS. 1 to 3 and 6, the curtain “A” cooperated with the balance member 2 of the present invention is Venetian blinds and comprises a top head 11 which is an inverted U-shaped case and a driving device 12 is received in the top head 11. Multiple ropes 14 are connected to and controlled by the driving device 12, the ropes 14 connect a plurality of slats 13.

A balance member 2 is a substantially L-shaped member and includes a top 21 to which the last one of the slats 13 is fixed. A plurality of connection members 24 extend through holes 25 defined through the horizontal portion of the balance member 2 and are fixed to the ropes 14 so as to connect the balance member 2 and the curtain “A”. The balance member 24 includes an extension portion 22 extending from the lower edge of the vertical portion of the balance member 24 and is connected to a cylindrical portion 23 which can be a hollow tube or solid rod. A recess 231 is defined between the extension portion 22 and the cylindrical portion 23. The recess 231 is located at the rear side of the vertical portion of the balance member 2 so that the user can easily hold the cylindrical portion 23 to operate the balance member 2 as a handle.

Each of the connection members 24 includes a pin 26 which has an end flange 262 with a shank extending therefrom, a passage 261 is defined radially through the shank and a stop flange 263 extends radially from the shank. The shank extends through the hole 25 defined through the balance member 2 and the rope 14 is tied in the passage 261.

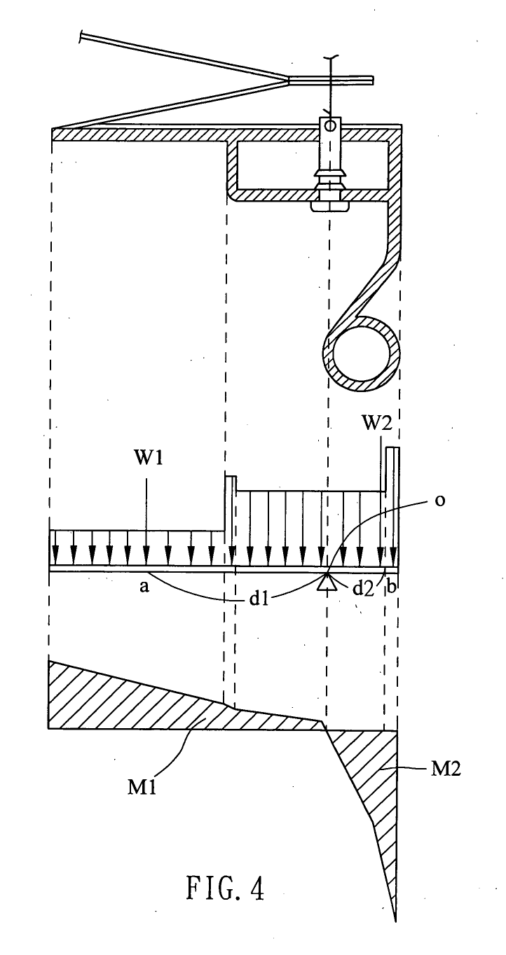

As shown in FIG. 4, the connection members 24 are functioned as fulcrum at point “O”, and the weight on two sides of the point “O” apply two respective downward forces “W1” and “W2” relative to the point “O” and form two torques “M1” and “M2” in opposite directions. The “W1” applies on the point “a” which is located at a distance “d1” from the point “O”, and the “W2” applies on the point “b” which is located at a distance “d2” from the point “O”. “M1” equals to the produce of “W1”×“d1” and “M2” equals to the produce of “W2”×“d2”. The connection members 24 are positioned such that a torque balance is established relative to the connection members 24, that is to say, “M1”=“M2”. By this specific arrangement, the balance member 2 does not tilt and the slats 13 are not dragged to become a curved surface.

The balance member 2 improves all of the shortcomings of the conventional curtain and the balance member 2 can also be functioned as a handle for cord-less curtains.

While we have shown and described the embodiment in accordance with the present invention, it should be clear to those skilled in the art that further embodiments may be made without departing from the scope of the present invention.

What is claimed is:

1. A curtain comprising:
a top head and a driving device received in the top head, multiple ropes connected to the driving device and connecting a plurality of slats, and
a balance member having a top to which the last one of the slats is fixed and a plurality of connection members extending through the balance member and fixed to the ropes, the connection members being positioned such that a torque balance is established relative to the connection members.

2. The curtain as claimed in claim 1, wherein the balance member includes a cylindrical portion connected longitudinally to a lower edge thereof.

3. The curtain as claimed in claim 2, wherein an extension portion extends from the lower edge of the balance member and is connected to the cylindrical portion, a recess is defined between the extension portion and the cylindrical portion.

4. The curtain as claimed in claim 2, wherein the cylindrical portion is a hollow tube.

5. The curtain as claimed in claim 1, wherein each of the connection members includes a pin which has an end flange with a shank extending therefrom, a passage is defined radially through the shank and a stop flange extends radially from the shank, the shank extends through a hole defined through the balance member and the rope is tied in the passage.
